(19) United States
(12) Patent Application Publication
(10) Pub. No.: US 2024/0187986 A1
(43) Pub. Date: Jun. 6, 2024

(54) SYNC SCATTER LOW POWER BACKSCATTER WAKE UP RECEIVER

(71) Applicant: The Regents of the University of California, Oakland, CA (US)

(72) Inventors: Manideep Dunna, La Jolla, CA (US); Miao Meng, La Jolla, CA (US); Po-Han Peter Wang, La Jolla, CA (US); Chi Zhang, La Jolla, CA (US); Patrick Mercier, La Jolla, CA (US); Dinesh Bharadia, La Jolla, CA (US)

(21) Appl. No.: 18/553,617

(22) PCT Filed: Mar. 31, 2022
(86) PCT No.: PCT/US2022/022725

§ 371 Date: Oct. 2, 2023

Related U.S. Application Data
(60) Provisional application No. 63/170,032, filed on Apr. 2, 2021.

(51) Int. Cl. H04W 52/02

(52) U.S. Cl. CPC H04W 52/0216; H04W 52/0235

(57) ABSTRACT

A method for waking a transceiver for communicating directly with commodity Wi-Fi transceivers (TRXs) via backscatter modulation in an integrated tag device includes sensing an incident Wi-Fi-compliant wake-up signal with a wake-up stage. Upon wake-up, a payload packet is sensed with a sync stage, the sync stage having higher bandwidth and power than the wake-up stage, the sync stage enabling a backscatter transmission circuit in sync with the payload. A backscatter transceiver includes a wake-up receiver having an energy-detection based architecture and having circuitry to conduct a counter-based wake up responsive to two pre-specified WiFi compatible packets. A sync receiver is enabled by the wake-up receiver upon reception of the two pre-specified WiFi compatible packets, the sync receiver including circuitry to detect a payload packet and create a backscatter enable signal synced with a payload of the payload packet. A backscatter transmitter is enabled by the backscatter enable signal.

### PRIORITY CLAIM AND REFERENCE TO RELATED APPLICATION

The application claims priority under 35 U.S.C. § 119 and all applicable statutes and treaties from prior U.S. provisional application Ser. No. 63/170,032 which was filed Apr. 2, 2021.

### STATEMENT OF GOVERNMENT INTEREST

This invention was made with government support grant number 1923902 awarded by National Science Foundation. The government has certain rights in the invention.

### FIELD

A field of the invention includes wireless communications, communications with commodity Wi-Fi transceivers, and low-power wake-up of wireless receivers via Wi-Fi.

TABLE OF ACRONYMS

| | |
|---|---|
| AP | Access Point |
| ASK | Amplitude Shift Keying |
| BLE | Bluetooth Low Energy |
| BPSK | Binary Phase Shift Keying |
| Bps | Bits Per Second |
| CW | Continuous Wave |
| CSI | Channel State Information |
| CMOS | Complementary Metal Oxide Semiconductor |
| DIFS | Distributed Interframe Space |
| dBi | Antenna Gain |
| dBm | Decibel Milliwatts |
| ED | Envelope Detector |
| GHz | Gigahertz |
| IC | Integrated Circuit |
| IF | Intermediate Frequency |
| IoT | Internet of Things |
| IRR | Image Rejection Ratio |
| IQ | In Phase and Quadrature |
| LNA | Low-Noise Amplifier |
| LO | Local Oscillator |
| LSB | Lower Sideband |
| Mbps | Megabits Per Second |
| MUX | Multiplexer |
| NFC | Near Field Communications |
| NMOS | N Channel MOSFET |
| OOK | On Off Keying |
| PA | Power Amplifier |
| PLL | Phase Locked Loop |
| PSK | Phase Shift Keying |
| QPSK | Quadrature Phase Shift Keying |
| RCC R | Resistor Capacitor Capacitor Resistor |
| RF | Radio Frequency |
| RFID | Radio Frequency Identification |
| RSSI | Received Signal Strength Indicator |
| RX | Receiver |
| SSB | Single Sideband |
| TRX | Transceiver |
| TX | Transmitter |
| USB | Upper Sideband |
| VBS | Body-to-Source Substrate Bias |
| VCO | Voltage Controlled Oscillator |
| Wi-Fi | Wireless Compatible with the Wi-Fi Alliance |
| WuRX | Wake Up Receiver |
| XOR | Exclusive OR function |
| XTAL | Crystal |

The following table defines acronyms/abbreviations:

### BACKGROUND

Wi-Fi is the only non-cellular pervasive wireless network infrastructure in place today. This is why most IoT devices must connect to the internet via Wi-Fi. A problem is that conventional Wi-Fi transceivers have power demands that conflict with the very low power ideal of IoT devices. Conventional Wi-Fi transceivers require 10s to 100s of mW of active power from RF blocks such as LNAs, LO frequency generation and stabilization, and power amplifiers (PAs), in part due to strict performance demands imposed by the IEEE 802.11-based standards. As a result, nearly all current Wi-Fi compatible IoT devices require either wall power, or large and/or frequently re-charged batteries.

While other standards with lower standards-based performance requirements, such as BLE, may achieve very low average power (<<1 mW) via duty-cycling at the expense of throughput and latency, very small coin cell batteries or energy harvesters still cannot be used due to relatively high peak power requirements (e.g., a few mW for BLE). More importantly, standards such as BLE do not have widely distributed infrastructure in most homes, offices, or other environments, which makes rapid low-cost deployment difficult.

To enable a new class of miniaturized, battery-powered or energy-harvested IoT devices, backscatter communication, where an incident RF source is reflected via a low-power impedance modulating tag, has been proposed [1]. However, most current solutions rely on custom tone generators [1,2], and thus cannot be rapidly deployed at scale with low cost. To enable operation with existing infrastructure, recent work has shown that already-pervasive Wi-Fi signals can be used as incident RF sources for backscattering, and through techniques such as codeword translation, commodity Wi-Fi RXs can be used to receive backscattered data [3,4]. However, the demonstrated technique required a Wi-Fi RF source (such as a smartphone) within 6 m of the tag, and two separate Wi-Fi readers within 8 m.

Perhaps the most popular technologies leveraging backscatter communications today are NFC and RFID tags. NFC tags are widely used in applications such as contactless payment systems and electronic keycards, use near-field inductive coupling between two coils to transmit data, which limits the operating range to within approximately 10 cm of the source. For this reason, NFC is not well suited for most IoT applications. However, because of its inductive coupling mechanism, NFC tags normally operate at 13.56 MHz and are resilient to RF interference. RFID tags, which can be widely seen in applications such as highway electronic toll system and inventory management system, use far-field radiative coupling for transmission. RFID tags normally operate at 0.4-2.4 GHz, and meters of communication range are achievable. RFID tags are suitable for IOT devices in terms of range and power. However, the conventional RFID tags have limitations that are less than ideal for IoT device applications.

One limitation concerns spectral efficiency. Conventional RFID tags receive a CW signal and reflect it with data modulation limited to ASK or OOK only. These techniques are not spectrally efficient.

Another limitation concerns interference resiliency. Because the downlink incident wave is a CW signal, and the uplink reflected wave is an ASK/OOK signal, RFID tags are very susceptible to RF interference. To solve this issue, normally the direction and location of the CW source (e.g., RFID readers) are optimized, for example, inside a warehouse using an RFID inventory management system. This is not practical for mass IoT devices coexistence at home or in urban areas.

An additional limitation concerns compatibility with existing standards and low-cost deployment. To generate a CW incident wave and be able to demodulate the reflected signal, a dedicated RFID reader hardware is required. However, this approach contradicts the target of cost-effective direct deployment that leverages well-established standards such as Wi-Fi.

Backscatter Wi-Fi has been proposed. However, none of the proposed techniques meets the need of using only commodity Wi-Fi hardware with a low-power backscattering integrated circuit, good sensitivity and high data rates.

One proposed Wi-Fi compatible solution is called Wi-Fi Backscatter [5]. A Wi-Fi access point (AP) transmits the signal to both the tag and the receiving Wi-Fi station, while the tag modulates the channel RSSI by absorbing and backscattering the signal alternately with the tag's data. This ASK-modulated signal (modulated in terms of RSSI) can be demodulated by the receiving Wi-Fi station via checking the CSI or RSSI, which are normally provided in state-of-the-art Wi-Fi chipsets. This is a good hardware approach, but the approach uses the entire Wi-Fi packet as a single bit, and therefore achieves very low data rate (100 s of bps). Moreover, the inherent lower sensitivity RSSI receiver from the standard chips along with ambient noise in the implemented system limited the range to only 0.65-2.1 m.

Another solution, called passive Wi-Fi, [2], was designed to improve upon the approach discussed in the previous paragraph. This passive Wi-Fi approach uses a conventional TX architecture to generate an IEEE 802.11b baseband signal directly. Instead of generating the power-hungry RF LO locally, a single tone RF source provides the RF LO outside, and the Wi-Fi compatible packet is synthesized by combining the baseband signal with the incident LO via backscatter modulation through the antenna. Although this method can enable a low power tag, only the uplink is Wi-Fi compatible, while the downlink still requires custom hardware to generate the CW signal.

A solution to this issue called Hitchhike is proposed in [3] and can achieve Wi-Fi compatibility in both the downlink and the uplink. A Wi-Fi signal generated by a mobile phone creates the incident signal received by the IoT tag. The tag performs PSK-based modulation on each symbol of the incident wave, which creates a backscatter signal on a different channel for reception by a Wi-Fi AP2. Meanwhile, the original un-disturbed Wi-Fi transmission from the mobile phone is received by AP1. Thus, API has the original phone data, while AP2 has phone data that has been phase modulated by the IoT tag. By connecting the two APs through the cloud, both data are available to a decoder. This decoder employs a technique called codeword translation to decode the tag's data. Theoretically, there is only the need for one Wi-Fi transmitter and one receiver in this approach. However, the limited range of the downlink wake-up receiver required use of a third device (the mobile phone) to close a reasonable link budget.

Wang et al PCT Published Application WO 2021/136480 describes a method for communicating directly with commodity Wi-Fi transceivers (TRXs) via backscatter modulation in an integrated tag device. Disclosed circuits allow receives to be woken up directly via a Wi-Fi TRX using a 2.8 μW wake-up receiver with −42.5 dBm sensitivity—good enough for >30 m wake-up range, and backscatters to a frequency-translated Wi-Fi channel via an on-chip 28 μW single-side-band QPSK modulator. Wireless tests revealed a range of 21 m between Wi-Fi access points.

All of the above-described methods fail to guarantee an accurate synchronization to an incoming wake-up signal. This can cause decoding problems and errors. Specifically, misalignment between the backscatter symbol timing and the original symbols in the Wi-Fi packet will start to change the barker code, which hurts the signal to interference ratio. To combat the synchronization problem, [3] uses a preamble to help the receiver find the start of backscatter data in the packet and decode the tag data. Further, to ensure proper decoding of tag data, each tag data bit is repeated multiple times (repetition coding), reducing the available throughput. Significant SNR gain is lost through this solution. A more severe consequence is that the CRC(cyclic redundancy check) of the packet often fails with past methods and systems, i.e., with some existing hardware.

### REFERENCES

[1] A. Shirane et. al., “A 5.8 GHz RF-Powered Transceiver with a 113 μW 32-QAM Transmitter Employing the IF-based Quadrature Backscattering Technique” in Proc. ISSCC Technical Digest, 2015.
[2] JB. Kellogg et al., “Passive Wi-Fi: bringing low power to Wi-Fi transmissions,” in Proc. of the Conference on Networked Systems Design and Implementation, pp. 151-164, 2016.
[3] P. Zhang et al., “HitchHike: Practical Backscatter Using Commodity Wi-Fi,” In Proc. of the ACM Conference on Embedded Network Sensor Systems, pp. 259-271, 2016.
[4] P. Zhang et al., “FreeRider: Backscatter Communication Using Commodity Radios,” In Proc. of the International Conference on Emerging Networking Experiments and Technologies (CoNEXT '17), pp. 389-401. 2017.
[5] B. Kellogg, A. Parks, S. Gollakota, J. R. Smith, and D. Wetherall, “Wi-Fi Backscatter: Internet connectivity for RF-powered devices,” in Proc. ACM Conf. SIGCOMM, August 2014, pp. 607-618.
[6] P.- H. P. Wang, C. Zhang, H. Yang, D. Bharadia, and P. P. Mercier. “A 28 μw IOT tag that can communicate with commodity Wi-Fi transceivers via a single-side-band QPSK backscatter communication technique,” 2020 IEEE International Solid-State Circuits Conference-(ISSCC), pages 312-314. IEEE, 2020.
[7] Wang et al., “A Low-Power Backscatter Modulation System Communicating Across Tens of Meters With Standards-Compliant Wi-Fi Transceivers,” IEEE JOURNAL OF SOLID-STATE CIRCUITS, VOL. 55, NO. 11, November 2020.

### SUMMARY OF THE INVENTION

A preferred embodiment provides a method for waking a transceiver for communicating directly with commodity Wi-Fi transceivers (TRXs) via backscatter modulation in an integrated tag device. The method includes sensing an incident Wi-Fi-compliant wake-up signal with a wake-up stage. Upon wake-up, a payload packet is sensed with a sync stage, the sync stage having higher bandwidth and power than the wake-up stage, the sync stage enabling a backscatter transmission circuit in sync with the payload.

A backscatter transceiver includes a wake-up receiver having an energy-detection based architecture and having circuitry to conduct a counter-based wake up responsive to two pre-specified WiFi compatible packets. A sync receiver is enabled by the wake-up receiver upon reception of the two pre-specified WiFi compatible packets, the sync receiver including circuitry to detect a payload packet and create a backscatter enable signal synced with a payload of the payload packet. A backscatter transmitter is enabled by the backscatter enable signal.

### BRIEF DESCRIPTION OF THE DRAWINGS

FIG. 1A is a generalized block diagram of a preferred backscatter modulator wake-up transceiver integrated circuit including wake-up and sync stage circuits;

FIG. 1B is a block diagram a preferred backscatter modulator wake-up transceiver integrated circuit with the FIG. 1A circuit and a preferred backscatter circuit to interface with multiple antennas (MIMO) or via a fully reflective termination;

FIG. 1C shows a state diagram of a preferred wake-up scheme for the transceiver of FIG. 1A;

FIG. 1D is a signal diagram showing wake-up, synchronization and backscatter timing of the FIG. 1B circuit;

FIG. 1E illustrates the preferred hierarchical wake-up scheme with respect to WiFi, sampling and baseband signals, showing that the present wake-up transceiver can tolerate a delay in packet arrival;

FIG. 2A illustrates the reflective termination of the FIG. 1B transceiver circuit;

FIG. 2B shows the received and backscattered fully reflected signal representation of at the reflective termination of FIG. 1B transceiver circuit;

FIG. 3 illustrates the MIMO circuit and an antenna array of the FIG. 1A transceiver circuit;

FIGS. 4A-4E show preferred circuit implementations respectively for the passive envelope detector in the wake-up receiver, the low-noise amplifier and active envelope detector in the synchronization receiver, an integer-N phase-locked loop (PLL) in the modulator, the IF mixer (in block diagram form), and the matching network.

### DETAILED DESCRIPTION OF THE PREFERRED EMBODIMENTS

This invention provides an integrated circuit demonstrating synched Wi-Fi-compatible backscatter-based communication with a hierarchical architecture that includes a separated wake-up and synchronization functionality that provides increased sensitivity compared to the state-of-the art described in the background. In contrast to prior approaches, the inventors have realized that high bandwidth needed for synchronization only needs be active when backscatter is enabled, i.e., after wake-up is conducted with very low power. By duty-cycling in this manner, average power consumption is significantly reduced. For example, the sync receiver needs to be turned on only for 50 us throughout a 500 μs wakeup+2000 μs data packet duration. The duty-cycled power, in this example, turns out to be

$$\frac{50}{2500} \times 240 μW = 4.8 μW .$$

Preferred circuits and wake-up methods create a two-stage, hierarchical wake-up and synchronization protocol, wherein a first stage (the wake-up receiver) is designed with single-digit microwatt power and leverages low-bandwidth energy detection to simply wake-up the tag at approximately the right time, at which point a second stage (the synchronization receiver) uses higher-power active RF amplification to enable the desired sensitivity at the desired bandwidth, but is turned on only for a short time to synchronize, and is powered down immediately post synchronization.

A preferred method creates a new protocol where two packets with controlled length are sent apriori to backscattering. The time duration of the two packets encodes the tag's identity, which results in an enable signal from the first stage wake-up receiver. The second stage turns on just before the start of the backscatter payload packet, samples the incoming signal at high bandwidth, looking for the beginning of the packet and the symbol boundary, and then promptly goes to sleep, i.e. the second stage goes to sleep immediately after detecting the packet and while the backscatter transmission is occurring. Once symbol-level synchronization is achieved, the backscatter modulation logic reflects the incoming signal by overlaying its data in a synchronized fashion.

An example circuit of the invention that has been fabricated is an RF integrated circuit and hardware design for the entire hierarchical wake-up protocol, along with single-sideband backscattering circuits, which can backscatter any ISM 2.4 GHz signals. A WiFi transmitter and receiver were implemented using open-wrt on TP-Link devices and were evaluated in indoor office environments. Testing showed that a prototype achieves a sensitivity of up to −35 dBm via the custom integrated circuit, with a synchronization accuracy of 150 ns, which enables a 30+ meter link operation as measured in a regular office environment. As a result, the longer wake-up distance offered by a present wake-up transceiver allows the use of WiFi APs deployed in a typical home or office environment without requiring additional smartphones, unlike in HitchHike.

A tag with a transceiver of the invention enables symbol-level synchronization at very low power consumption by utilizing a hierarchical wake-up receiver with a false negative rate of 10⁻³. It also supports backscatter communication over a wide range of the transmitter(Tx) to tag and receiver(Rx) to tag distances whose product is ≤169 m², i.e., 13 m from Tx and 13 m from Rx or 33 m from Tx and 5 m from Rx. Additionally, it supports multiple tags running concurrently and supports 802.11b waveforms, modulating at symbol level providing peak bit-rates of 500 Kbps.

Preferred embodiments of the invention will now be discussed with respect to experiments and drawings. Broader aspects of the invention will be understood by artisans in view of the general knowledge in the art and the description of the experiments that follows.

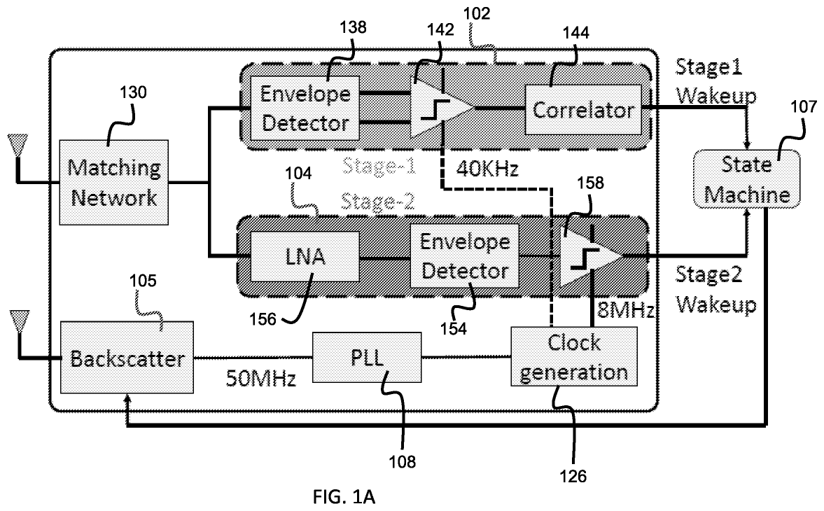

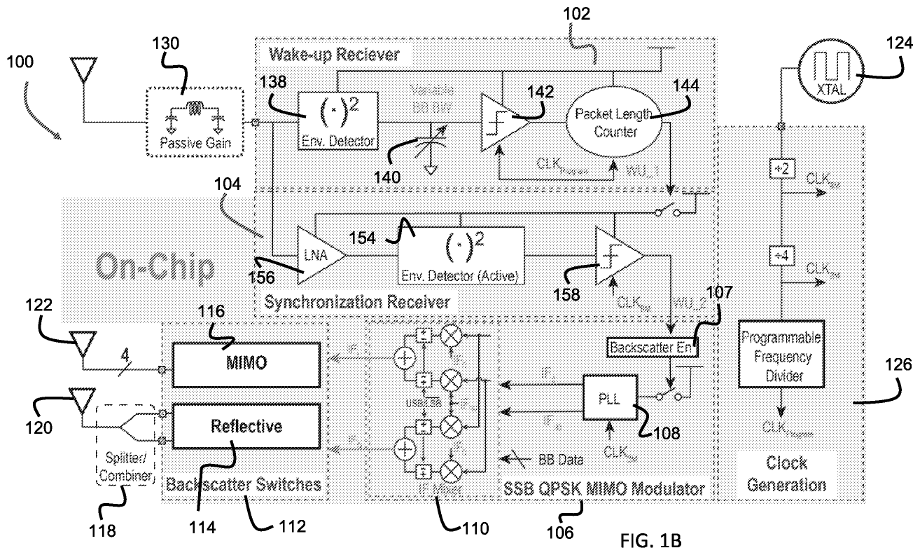

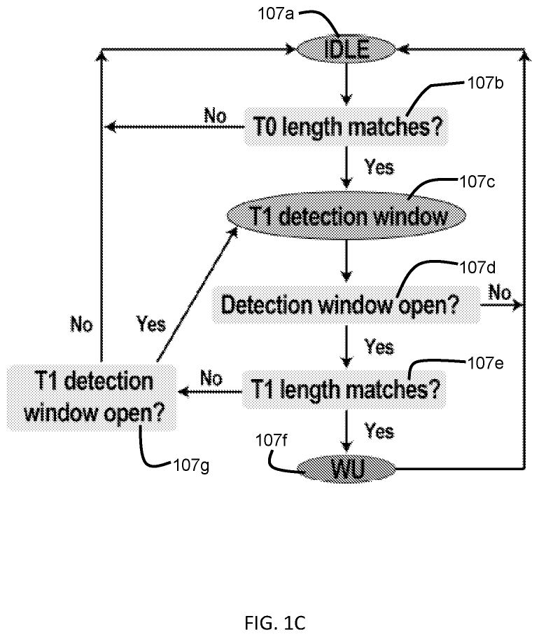

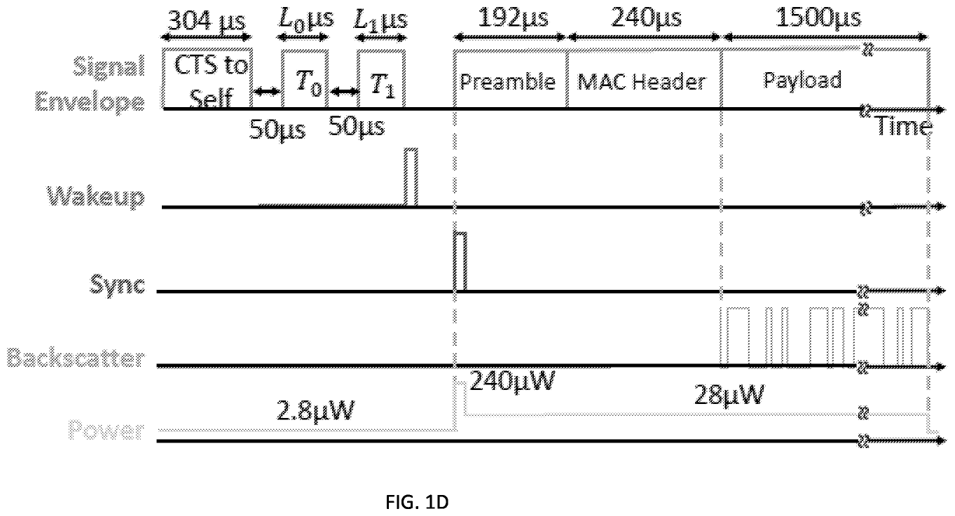

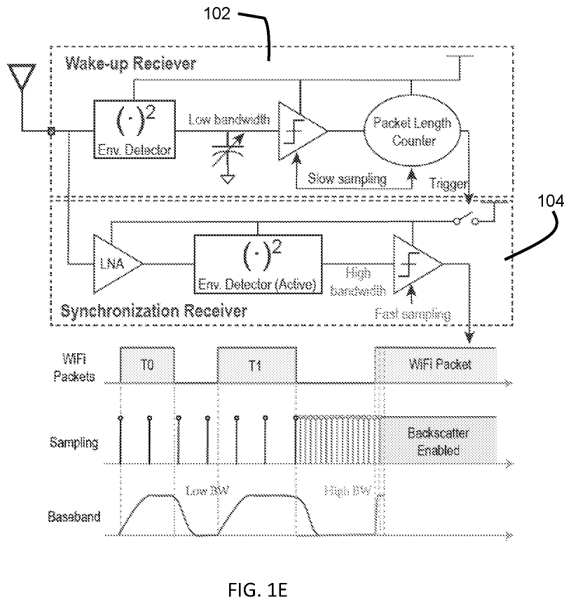

FIGS. 1A and 1B illustrate a preferred embodiment backscatter transceiver integrated circuit 100 that can function in a backscatter tag device. The transceiver circuit 100 includes a wake-up receiver 102 (stage-1) implemented with an energy-detection based architecture for low standby power, and implements a counter-based scheme for robust wake-up with fully WiFi compatible packets. A synchronization receiver 104 (stage-2) is triggered by the wake-up receiver 102 to improve the synchronization accuracy to below 150 ns. The wake-up stage's 102 goal is to monitor the RF spectrum for a pre-specified set of packets that indicate the next packet is the one to be backscatter modulated. Preferably, this is conducted with the same sensitivity as the sync stage receiver 104, but at much lower power because the wake-up stage 102 is active for much longer periods. If the wake-up stage is sufficiently low power, and the sync stage only needs to operate over a small duty-cycle, then the overall hierarchical approach can consume low average power. Upon completing the downlink via the stage 102, the tag activates the sync receiver 104 to acquire synchronization to uplink the data.

FIG. 1A shows a general backscatter switching and IF mixing circuit 105 driven by a PLL 108. FIG. 1B shows additional details with a preferred backscatter switching circuit 112 options of a fully reflective circuit 114 with a splitter 118 as will be further described. Applicant notes that the FIG. 1A general backscatter switching arrangement can also be that used in the backscatter wake-up transceivers disclosed in the background, including that in Wang et al PCT Published Application WO 2021/136480. Those arrangements will benefit from the present wake-up 102 and synchronization 104 stages. The following discussion of the preferred FIG. 1B implementation includes a detailed explanation of the present wake-up 102 and synchronization 104 stages.

FIG. 1C shows a state diagram of a state machine 107 for a preferred wake-up scheme for the transceiver of FIGS. 1A-1B, which is implemented in FIG. 1B with the wake-up stage 102, as the packet length counter performs the counting required by the state machine 107. With reference to FIG. 1C, the wake-up scheme uses a counter to measure the length of two pre-specified WiFi compatible packets lengths. In an initial state 107a, the state machine 107 is idle. The counter 144 (FIG. 1B) measures the length of the first packet T0 in state 107b, and a detection window with either a predetermined or programmable opening time is initiated in state 107c if length of T0 matched the pre-specified length. A programmable opening time is preferred because programmability helps operate multiple tags simultaneously where one can associate a different wake up pattern (different T0 or T1 durations) to different tags. If the transmitted wakeup pattern matches the programmed wakeup pattern on a tag, only that tag wakes up and the rest of the tags will not respond to the wakeup pattern. Generally, the detection window can be programmed in with the limitation that the duration is chosen to satisfy the minimum gap duration between two WiFi packets. If the second correct packet T1 is received in state 107e within the detection window in state 107d, the transceiver tag is waked in state 107f. The wake-up then RX continuously looks for T1 in steps 107g and 107c-107e until it is the received while the window is open, or detection window is closed at the end of the allowed period for detection. The wake-up scheme of FIG. 1C that is enabled by the FIGS. 1A-1B allows robust wake up based on the lengths of T0 and T1 despite of the uncertain interframe space time in between, even in crowded networks. In addition, the scheme supports multi-tag communication by assigning different combinations of T0 and T1 lengths.

FIG. 1D illustrates timing for wake-up and communication. The wake-up pattern is constructed as follows. A WiFi-compatible identifier is transmitted by a WiFi AP first consisting of a CTS-to-self to temporarily reserve the channel, followed by the transmission of two packets, T0 and T1, with pre-determined lengths corresponding to the IoT tag that is supposed to be woken up. Multiple tags can then be uniquely woken up by choosing different T0 and T1 packet lengths. At the tag level, the wake-up stage uses an 8 dB passive voltage gain network that is directly connected to an ED. The ED energy detects the entire packets and samples the energy with a comparator. Since the packet lengths are restricted to a minimum 50 μs, the required ED baseband bandwidth is 20 kHz. With 8 dB of passive voltage gain, this results in a sensitivity of −40 dBm—which is the desired level (with margin). The comparator's output passes into a counter that counts the number of logic ‘1’s, given by the presence of a packet (vs. a logic ‘0’, which would occur in the inter-packet interval), at a sampling rate of 40 kHz. If the expected number of 1's and 0's occur in the right order, the wake-up stage's 102 output triggers the sync stage receiver 104. Importantly, this wake-stage is achieved with a purely passive ED 138 that consumes zero power. As a result, the only power here is that of the comparator 142, correlator (packet length counter) 144, and clock generator 126, which together consume only 2.8 μW during active mode. In an example prototype, the 16 MHz crystal oscillator clock 124 is divided on chip into 8 MHZ, 2 MHz and 40 kHz in the generator 126 to be used by sampling clocks for sync receiver, PLL reference clock and sampling clock for wake up receiver, respectively. To drive the backscatter modulator, an integer-N PLL 108 is adopted with a 2 MHz reference frequency and a dividing ratio of 25. The voltage-controlled oscillator is implemented via a current starved ring oscillator with tunable current to ensure stable clock generation against PVT variations and it consumes 1.5 μW power.

Consider the end-to-end life-cycle of data packet exchange from an IoT device with a transceiver 100 of the invention to the WiFi AP. A WiFi AP with the firmware support to transmit an excitation signal transmits a CTS-to-self packet to reserve a slot of 5 milli-second. Next, the transmitting AP transmits the two packets T0 and T1, whose lengths are a multiple of 25 μsec. The tag notices a special pattern of three packets using the wake-up stage receiver by measuring the duration of CTS-to-self, T0, and T1 packets.

Each IoT device with a transceiver 100 is pre-coded (via the programmable counter/correlator 144) with the lengths for T0 and T1 (akin to a destination address), which is the tag's identity. The finite state machine (FIG. 1C) at the tag continuously runs the wake-up receiver 102 to look and match the three packet durations consuming 3 μW, with the trigger level of the reference voltage for ED set to −40 dBm. Whenever the three measured lengths match with the precoded sequences, it enables the specific IoT device to receive the downlink data.

A fixed number of bits are allocated for downlink in the finite state machine. The AP transmits the packets with varying lengths to encode the downlink data with 25 μsec granularity. The wake-up receiver at the IoT device uses the packet length to decode the downlink message. Therefore, the downlink data-rate supported is 40 Kbps. 3 bits can be reserved for down-link, which bits are used to set the reflection side-band upper or lower.

Upon completing the downlink, the tag fires up the sync receiver at the IoT device to acquire synchronization to uplink the data. The AP transmits a longer packet which we use to uplink the data. The tag synchronizes to the receiving packet with 150 ns accuracy, assuming incoming power is higher than −40 dBm. The tag starts backscattering at 50 MHz without any data, as soon as it receives a trigger from the sync receiver. Back-scattering with no-data ensures the incoming packet is reflected on channel 11, assuming transmission was on channel 1. The receiving AP on channel 11 starts receiving the packet. It successfully receives the PHY and MAC header of a total of 432 μsec. Upon completion of 432 μsec, the IoT device starts backscattering data, which is compliant to WiFi standards, as discussed in the next section. The receiving AP decodes the packets successfully, with CRC matching ensuring the packet is reported to the higher layers. The receiving AP XORs its data with the trans-mitted data in the cloud to recover data from the IoT device, thus connecting the IoT device to the AP.

The sensitivity of a direct ED receiver is given by:

$${P}_{sensitivity} = \frac{20}{{k}_{E D} * {A}_{v}^{2}} \sqrt{B {W}_{B B} * P S {D}_{0} * S N {R}_{MIN}} \qquad ( 1 )$$

where K_{ED} is the scaling factor of the envelope detector, Aᵥ² is the font-end voltage gain, PSD₀ is the output-referred baseband noise, and SNR_{MIN} is the required minimum signal-to-noise ratio. Assume the baseband is sampled at the Nyquist rate, this means a baseband bandwidth of at least 6.7 MHz is needed to achieve synchronization accuracy of 150 ns. However, with such bandwidth, it is impossible to achieve a sensitivity of −35 dBm. Adding RF gain is the most efficient or the only way to improve the sensitivity, which is typically undesired due to the high power consumption since the wake-up receiver is always turned on.

A transceiver of the invention instead relies upon the hierarchical wake-up scheme, which is shown in FIG. 1E with packet, sampling and baseband signals. With this timing only the wake-up RX 102 is always on, the power-hungry synchronization RX 104 is deeply duty-cycled. The low-power wake-up RX 102 has low bandwidth and implemented to trigger the synchronization RX 104. When wake-up packets are detected, synchronization RX 104 is turned on for a short period of time, operating with high bandwidth to detect the rising edge of the data packet. Once the beginning of the data packet is detected, synchronization RX 104 goes back to sleep mode to save power. Single digit uW average power can be achieved with the FIGS. 1C-1E hierarchical wake-up. After synchronization, the tag transceiver 100 first backscatters the 192 us packet header (with frequency translation) to receiving AP2 without any phase alteration to ensure correct reception by AP2. After the header, the payload data is modulated by the tag data and then backscattered to AP2. Finally, AP1 and AP2 recover the tag data in cloud by a codeword translation method that is described in P. P. Wang, C. Zhang, H. Yang, M. Dunna, D. Bharadia, and P. P. Mercier, “A Low-Power Backscatter Modulation System Communicating Across Tens of Meters With Standards-Compliant Wi-Fi Transceivers” in IEEE Journal of Solid-State Circuits, vol. 55, no. 11, pp. 2959-2969, November 2020.

Once the tag has woken up and the sync stage 104 identifies the exact packet start instant, the system starts backscattering with zero data. This ensures that the incident WiFi packet's header is backscattered to a different WiFi channel for reception by another WiFi AP without any modification using a Single side-band (SSB) modulation technique. While this is occurring, the tag counts the number of clock cycles until the header is complete, after which it can begin to introduce its data into the backscatter modulator. The backscatter data is XORed with the incident 11b symbol data, also known as code-word translation. The backscatter data is recovered at the receiving AP by XORing the received data again with the original 11b symbol data.

Returning to FIG. 1B, a preferred SSB QPSK modulator 106 is enabled by an enabler switch 107 (activated by the state machine of FIG. 1C) and driven by the PLL 108 to provide control signals for the backscatter switches via an IF mixer 110. A backscatter switching section 112 includes fully-reflective 114 and retro-reflective MIMO 116 circuits. This reflects a test chip, and a commercial implementation needs only one of the fully-reflective 114 and retro-reflective MIMO 116 circuits. The fully-reflective circuit 114 connects to a splitter/combiner 118 and an antenna array 120, while the retro-reflective MIMO circuit 116 connects to an antenna array 122. The antenna arrays 120 and 122 should have four antennae as a minimum for single-side band modulation. More antennae can be used, e.g. by replicating a first set of four antennae. A crystal oscillator 124 with divider logic 126 that provides global frequency generation for the transceiver integrated circuit 100.

Since RF voltage gain can directly improve the sensitivity of an energy-detection based RX, a matching network 130 can be employed to provide passive RF gain, e.g. 8 dB of gain. The wake-up signal is first amplified and filtered via the network 130 and then an envelope detector (ED) 138 directly demodulates the RF wake-up signal to baseband via its 2^{nd} order nonlinearity while a programmable capacitor 140 is used at the ED output to set the bandwidth for baseband signal filtering. The programmable capacitor 140 provides the ability to adopt different packet length and optimize sensitivity under different wake-up patterns. A fixed capacitor can be used for specific applications, e.g., where packet lengths and sensitivity requirements are determined and then an optical fixed capacitance can be selected. The ED output is then oversampled by a 40 kHz clock and digitized by a two-stage dynamic comparator 142 with a programmable threshold to reduce offset voltage issues and optimize sensitivity. The comparator output is then processed by a counter 144, e.g., and 8-bit counter, to count the packet length with programmable error tolerance to enable robust detection of the pre-specified WiFi signature. An 8-bit counter at 40 kHz is enough to detect packets of duration 6.4 ms which is much higher than the WiFi packet duration in a tested implementation. A counter with more than 8 bits can be implemented if needed.

The wake-up event triggers the synchronization stage 104, which shares the same antenna 150 and matching network as the wake-up RX 102. An active ED 154 with increased conversion gain via a low-noise amplifier 156 that ensures decreased noise is employed in synchronization RX for high bandwidth to enable high synchronization accuracy. The low-noise-amplifier 156 is adopted before the ED 154 to boost the RF gain to ensure the sensitivity while maintaining the high bandwidth. A similar comparator 158 as in the wake-up RX with tunable reference voltage is used after the active ED 154. The comparator is sampled with an 8 MHz sampling clock to meet the timing accuracy requirements. The synchronization RX 104 is tuned on until the rising edge of data packet. The synchronization RX 104 is turned off after successful detection of the data packet to save power (average of 50 μs in an example implementation).

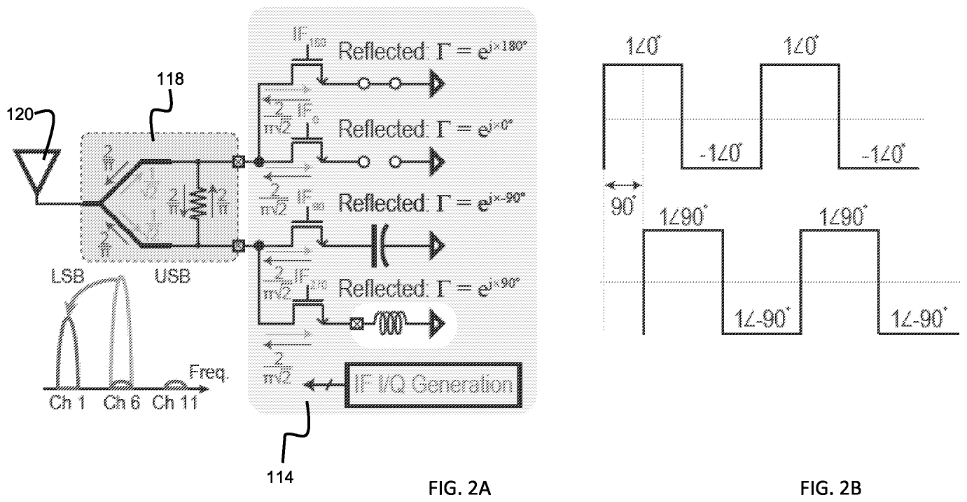

FIG. 2A illustrates the reflective termination 114 of FIG. 1B, and FIG. 2B the received and backscattered fully reflected signal representation. With the fully reflective termination 114, the top branch includes both open load and shorted loads, which have reflection coefficients of 1/0° and 1/180°, respectively. For this case, the reflected signal in the top branch increases by a factor of 2 and is equal to 2[sin(2 πf_{c}t)*Sₜ]. Similarly, the bottom branch is modified to have a capacitive and inductive load with reflection coefficients of 1/270° and 1/90°. The reflected signal in the bottom branch also increases by a factor of 2 and is equal to 2[sin (2 πf_{c}t)*S_{b}]. Sₜ and S_{b} are square waveforms of frequency f that have 90-degree phase offset. The total reflected signal rp1(t) is:

$$\begin{matrix}{r}_{p 1} ( t ) = \frac{1}{\sqrt{2}} [ \frac{1}{\sqrt{2}} sin ( 2 π {f}_{c} t ) * \frac{4}{π} sin ( 2 π f t ) - \\ \frac{1}{\sqrt{2}} cos ( 2 π {f}_{c} t ) * \frac{4}{π} cos ( 2 π f t ) \\ = \frac{2}{π} [ sin ( 2 π {f}_{c} t ) sin ( 2 π f t ) - cos ( 2 π {f}_{c} t ) cos ( 2 π f t ) \\ = \frac{2}{π} [ cos ( 2 π ( {f}_{c} + f ) t + π )\end{matrix} \qquad ( 2 )$$

This improves by 2 time the single amplitude compared to Wang et al PCT Published Application WO 2021/136480. This provides a 6 dB improvement in backscattered signal power and 3.94 dB insertion loss. The backscattered signal of the present approach contains only the frequency f_{c}+f, while also providing improved insertion loss. In FIG. 2A, the open branch has ideally infinite resistance while short has ideally zero. The capacitor preferably provides an ideal −90 degrees phase shift at 2.4 GHz, e.g., with 1.2 pF in an example implementation, and the inductor provides an ideal 90 degrees phase shift, e.g., with 3.3 nH in an example implementation.

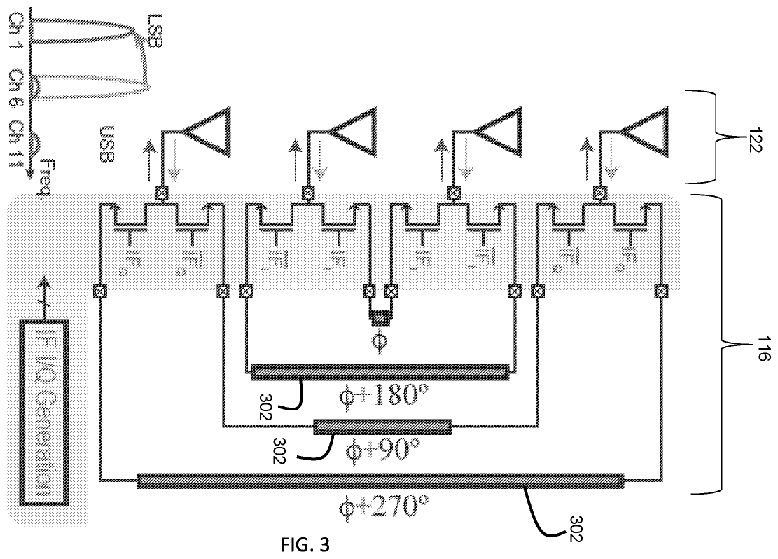

FIG. 3 illustrates the MIMO circuit 116 and an antenna array 122 of the FIG. 1A transceiver. MIMO conventionally requires multiple precision local oscillators with finely tuned phase delays to enable beam steering, which is completely impractical in a low-power IoT (Internet of things device) tag. The circuit of FIG. 3 avoids such impracticality with a Van Atta retro-reflector that reflects incident waves back to their source in a fully passive manner. This circuit eliminates the need for a power splitter and enables a self-steered beam with directional gain, thereby significantly extending the range. The MIMO circuit 11 includes a plurality of transmission lines 302.

By properly selecting the delay through the transmission lines 302 connecting each antenna of the array 122, incident RF signals at angle Θ will be re-radiated in a steered beam back at the same angle. Simply alternating between the re-radiation condition and a 50 Ω terminated condition at the BaseBand (BB) data rate could enable OOK backscatter, while mixing the BB with an IF clock could PSK backscatter at frequency-shifted channels. However, the generated double-sideband (DSB) signal undesirably occupies all three WiFi channels, and the periodically-absorbing condition reduces the amount of re-radiated power. To overcome these challenges, the FIG. 3 circuit is a Q-modulated Van Atta structure, where 90° and 180° transmission-line (TRL)-based delays are intentionally added between antennas to enable QPSK SSB reflections. The outer two antennas are connected by a switched pair of 270° and 90° TRLs and modulated by a Q-phase IF signal, similar to the fully-reflective approach of FIG. 2A when terminated with open load and capacitor, the reflective signal for each antenna is equal to 2[sin(2 πf_{c}t)*Sₜ]. However, a pair of antennae are used instead of a single antenna, so the total combined reflected signal at the RX location is equal to 4[sin(2 πf_{c}t)*Sₜ]. The inner two antennae are connected by a switched pair of 0° and 180° TRLs (i.e., 90° separated from the outer antennae) and driven by the I-phase IF signal, similarly, the combined signal from this pair at RX location is equal to 4[sin(2 πf_{c}t)*S_{b}]. The absolute value of the delay introduced by each transmission line can be changed, as long as there is a relative difference in delay between each line relative to the other lines. Also, while four antennas are shown with four transmission lines in FIG. 3, additional antennas and transmission lines can be added while maintaining a relative delay offset between each transmission lines and the other lines. In addition, since the lossy Wilkinson power combiner and splitter 118 is not needed, the two

$$\frac{1}{\sqrt{2}}$$

factors from Eq (2) are eliminated. Therefore, the total combined reflected signal rp2(t) for the proposed MIMO approach is:

$$\begin{matrix}{r}_{p 2} ( t ) = [ sin ( 2 π {f}_{c} t ) * \frac{8}{π} sin ( 2 π f t ) - \\ cos ( 2 π {f}_{c} t ) * \frac{8}{π} cos ( 2 π f t ) \\ = \frac{8}{π} [ sin ( 2 π {f}_{c} t ) sin ( 2 π f t ) - cos ( 2 π {f}_{c} t ) cos ( 2 π f t ) \\ = \frac{8}{π} [ cos ( 2 π ( {f}_{c} + f ) t + π )\end{matrix} \qquad ( 3 )$$

This provides a signal amplitude increase of additional four times more than the fully reflective circuit 114, an improvement over Wang et al PCT Published Application WO 2021/136480 of 18.06 dB and an improvement over the fully reflective circuit of 12.04 dB. As an example variation to FIG. 3 connections, Inner(0 and 180 degree) and outer pairs(90 and 270 degree) of transmission lines can be exchanged to change the side-band from Right side to left side. For example, in FIG. 3, the side-band(right/left) is being controlled by IF_I and IF_Q clocks, by either making IF_Q leading the IF_I by 90 degree or IF_Q lagging the IF_I clocks by 90 degree. If the inner and outer pair of transmission lines are interchanged, the IF_I ,IF_Q setting that would have given rise to right side band will result in left-side band had the pairs not been interchanged. Similarly, the IF_I and IF_Q setting that would have given rise to left side band will result in right side band had the pairs not been interchanged.

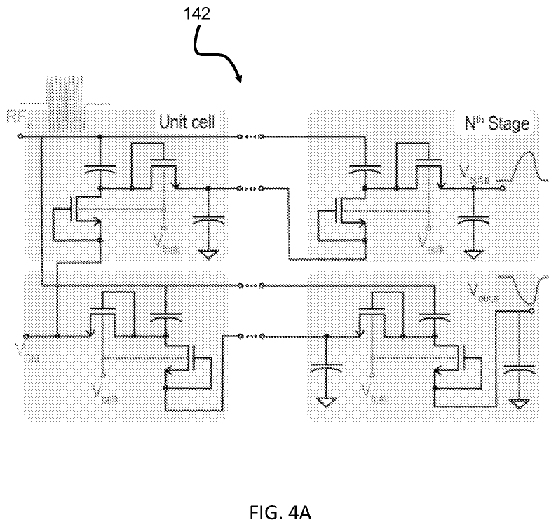

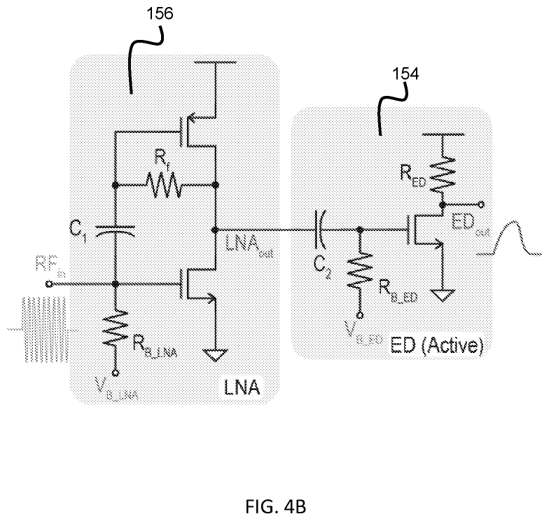

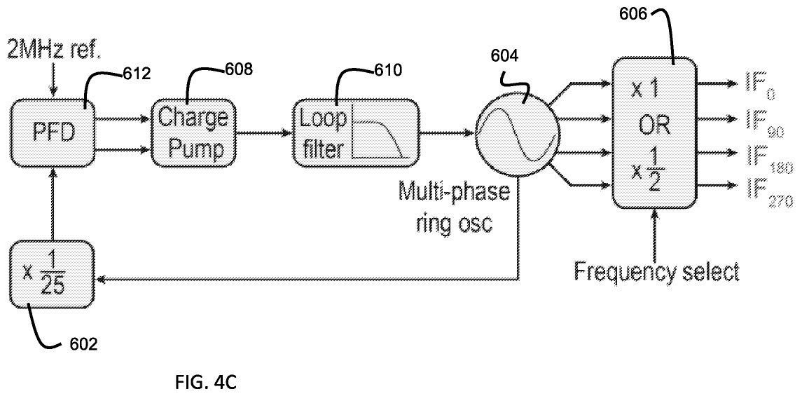

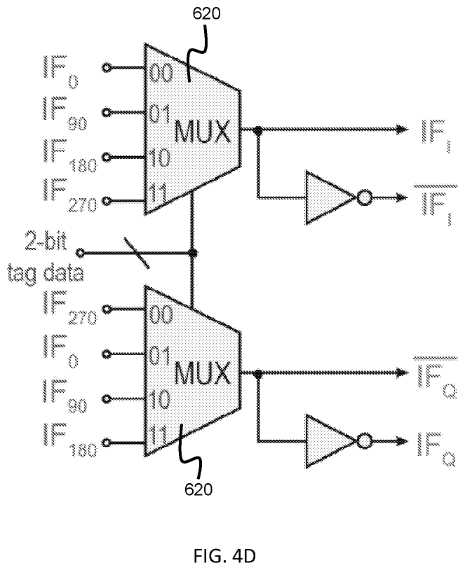

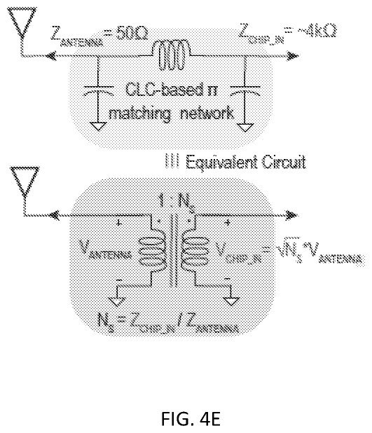

FIGS. 4A-4D show preferred circuit implementations. FIG. 4A shows the shows the passive pseudo-balun ED 142 of FIG. 1A. The ED 142 provides large input resistance to not degrade the passive voltage gain of the matching network 130, while provides sufficient output bandwidth for the baseband signal (200 kHz in this case) for sharp rising and falling time. It demodulates a single-ended input RF signal to differential output signal thanks to the pseudo-differential structure, enabling 2× conversion gain and 1.5 dB of sensitivity improvement under the same output bandwidth compared to its single-ended counterpart.

FIG. 4B shows the LNA 156 and active envelope detector 154. A current reuse common source amplifier is implemented to achieve an 11 dB gain with sufficiently low noise to meet the sensitivity requirement for synchronization RX. The output of LNA 156 feeds into the active ED 154. The ED is a common source ED and can be employed with an example bandwidth of 32 MHz to ensure a highly accurate rising edge timing. The ED is optimized via transistor size, resistor size, bias threshold in terms of conversion gain. Since the antenna is single-ended, high passive voltage gain is easier to achieve with a single-ended matching network. Thus, the ED should also be single-ended. However, in general, it is better to perform baseband signal processing in a differential manner. Considering that the input impedance, output referred noise, and conversion gain are all important parameters to optimize in ED design, a multi-stage fully passive ED design is employed.

In particular, a single-ended-to-differential Dickson-based topology is selected, thus acting as a pseudo-balun. The pseudo-differential outputs of the stage one ED then feed into a differential comparator based on a Strong-ARM regenerative latch topology. This comparator effectively acts as a 1-bit analog-to-digital converter (ADC), and thus to extract useful timing information, it must be oversampled. As a result, it is clocked at 40 kHz. This clock is derived directly from the on-board crystal, after an on-chip division by a factor of 400. The comparison threshold voltage is tuned by externally controlling the bulk voltages of the input pair of the preamplifier implemented by a gmC integrator.

FIG. 4C shows the preferred PLL 108 implementation. A standard type-II integer-N PLL is adopted with a divider 602 having ratio of 25. A 50 MHz IF clock is achieved from a 2 MHz reference clock generated by a crystal oscillator. A voltage controlled oscillator (VCO) 604 can generate, via a frequency selector 606, four clock phases with 90-degree difference for consecutive phases that are provided by the chain of ring oscillator 604. These clocks with four different phases are passed through divider logic 602 to alternate the frequency between 25 or 50 MHz to enable frequency translation from channel 6 to channel 1 or 11, or translation between channels 1 and 11 depending on application needs. The components are generally conventional with a charge pump circuit 608 is connected with a loop filter 610 and a phase frequency detector 612 that receives a reference signal. The charge pump 608 serves as a converter to analog for the logic states of the PFD 612, which signal controls the oscillator 604 via the loop filter such its frequency is controlled by the output signal of the charge pump 608.

FIG. 4D is a preferred implementation of digital SSB IF mixer 110. Two 4:1 MUX logics 620 with 90-degree rotate IF clock inputs are used. QPSK modulation can be achieved by controlling the MUXs 602 via a 2-bit tag data.

FIG. 4E is the circuit diagram of a preferred CLC-based x matching network. which provides 8 dB of voltage gain. The maximum achievable gain is limited by the quality factor, Q, of the constituent components at 2.4 GHZ, along with the input impedance of the ED. In a prototype implementation, the employed inductor's Q is 110.

The transceiver of FIG. 1B has been fabricated in a 65 nm process, with an active area of 0.44 mm². An on-board Wilkinson power combiner was implemented for the reflective termination approach, and for the MIMO approach, transmission lines with specific phase shifts were designed on board to satisfy the requirement to achieve MIMO-based SSB QPSK modulation with four equally separated antennas being connected to the chip through the four transmission lines with equal electrical length.

Testing showed a sensitivity of −43.4 dBm for a missed detection rate of 10⁻³, supporting >30 m AP-to-tag wake-up distance. Testing showed at least 150 ns jitter can be achieved for power level of −35 dBm or better. During wake-up mode, the chip consumes 4.5 μW to successfully wake-up to the desired signature, where 1.5 μW from the crystal oscillator, and 3 pW from the baseband and counter-based scheme. During synchronization mode, the synchronization stage consumes 240 μW, but only for an average of 50 μs corresponding to one cycle of 40 kHz sampling clock. For a nominal wake-up duration of 500 us and data packet duration of 2 ms, the duty-cycled power of synchronization stage is therefore 4.8 μW. During active mode, the backscatter IC consumes 32 μW for the fully-reflective approach and 38 μW for MIMO approach, both dominated by the power of stable clock generation to ensure low carrier frequency offset during channel frequency translation. The range limiting factors are comprehensively analyzed and a fully-reflective and a retro-reflective MIMO approaches readily supported communication ranges of 13 m and 23 m, respectively for a single AP environment.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for waking a transceiver for communicating directly with commodity Wi-Fi transceivers (TRXs) via backscatter modulation in an integrated tag device, comprising:
sensing an incident Wi-Fi-compliant wake-up signal with a wake-up stage;
upon wake-up, sensing a payload packet with a sync stage, the sync stage having higher bandwidth and power than the wake-up stage, the sync stage enabling a backscatter transmission circuit in sync with the payload.

2. The method of claim 1, wherein the sensing comprises using a counter to measure the length of two pre-specified WiFi compatible packets that define the wake-up signal.

3. The method of claim 2, wherein a detection window is opened after receiving a first of the two pre-specified WiFi compatible packets is detected.

4. The method of claim 3, wherein the sync stage is enabled only if a second of the two pre-specified WiFi compatible packets is detected within the detection window.

5. The method of claim 4, wherein the sync stage uses a preamble and header of the payload packet to sync the backscatter transmission circuit with a payload of the payload packet.

6. The method of claim 1, comprising reflecting the payload packet by encoding data from the tag device such that the reflected signal follows the Wi-Fi standard can be decoded by another WiFi-device.

7. A wake-up transceiver in an integrated tag device for communicating directly with commodity Wi-Fi transceivers (TRXs) via backscatter modulation comprising:
a wake-up receiver having an energy-detection based architecture and having circuitry to conduct a counter-based wake up responsive to two pre-specified WiFi compatible packets;
a sync receiver enabled by the wake-up receiver upon reception of the two pre-specified WiFi compatible packets, the sync receiver including circuitry to detect a payload packet and create a backscatter enable signal synced with a payload of the payload packet; and
a backscatter transmitter enabled by the backscatter enable signal.

8. The wake-up transceiver of claim 7, wherein the wake-up receiver comprises a passive envelope detector that demodulates a signal, baseband signal filtering, an oversampling analog to digital converter and a packet length counter for detection of two pre-specified WiFi compatible packets.

9. The wake-up transceiver of claim 8, wherein the passive envelope detector consumes zero power.

10. The wake-up transceiver of claim 8, wherein the only power consumed by the wake-receiver after receiving a first one of the two pre-specified WiFi compatible packets is consumed by the analog to digital converter the packet length counter and a clock generator.

11. The wake-up transceiver of claim 8, wherein the counter is pre-coded with lengths of the two pre-specified WiFi compatible packets, which lengths serve as an identity for the wake-up transceiver.

12. The wake-up transceiver of claim 8, comprising a wake-up enable switch from the packet length counter to enable the synchronization receiver upon detection of the a second of two pre-specified WiFi compatible packets.

13. The wake-up transceiver of claim 12, comprising a backscatter enable switch from the synchronization receiver to enable a backscatter modulator in sync with the payload of the payload packet.

14. The wake-up transceiver of claim 8, comprising a front-end matching network that provides passive gain to a received signal.

15. The wake-up transceiver of claim 14, wherein the passive envelope detector comprises a passive pseudo-balun envelope detector.

16. The wake-up transceiver of claim 7, wherein synchronization receiver comprises a low noise amplifier, an active envelope detector and an analog to digital converter.

17. The wake-up transceiver of claim 7, wherein the wake-up receiver is always powered and the sync receiver is duty-cycled to be on only to enable and sync the backscatter receiver in timing with the payload.
